(19) United States
(12) Patent Application Publication
(10) Pub. No.: US 2021/0103910 A1
(43) Pub. Date: Apr. 8, 2021

(54) MULTIPLE SETTLEMENT OPTIONS IN PAYMENT SYSTEM

(71) Applicant: Mastercard International Incorporated, Purchase, NY (US)

(72) Inventors: Shanthan Subramaniam, Baldwin Place, NY (US); Sandeep Malhotra, Greenwich, CT (US); Suman Rausaria, Ballwin, MO (US)

(21) Appl. No.: 16/593,080

(22) Filed: Oct. 4, 2019

(51) Int. Cl. G06Q 20/22; G06Q 20/02; G06Q 20/38

(52) U.S. Cl. CPC G06Q 20/227; G06Q 20/3821; G06Q 20/023

(57) ABSTRACT

A payment card account system transaction request is received. The request was initiated by acceptance of a payment card account transaction by a merchant. The request includes a transaction amount. It is determined whether the merchant has selected EFT (electronic funds transfer) settlement for the payment card account transaction that the merchant accepted. In response to the receiving step and also in response to a result of the determination as to whether EFT settlement was selected, an EFT transaction request is routed for the transaction amount to an EFT system to benefit the merchant.

### BACKGROUND

FIG. 1 is a block diagram that illustrates a conventional payment card account system 100.

The system 100 includes a customer device 102 such as a magnetic stripe card, a payment IC (integrated circuit) card (contactless and/or contact), or a payment-enabled mobile device. Block 104 in FIG. 1 represents a merchant device such as a POS (point of sale) terminal/card reader. The merchant device 104 may also be considered part of the payment card account system 100. The customer device 102 may be presented to the merchant device 104, to consummate a purchase transaction and to permit the merchant device 104 to read payment card account data (including, e.g., a payment account number) from the customer device 102. In other situations, the merchant device 104 may be an e-commerce server computer, and the customer device 102 may be a personal computer, a mobile device running a mobile browser, etc.; in such situations, the customer device 102 may engage in an online shopping session with an e-commerce website hosted by the merchant device 104.

A computer 106 operated by an acquirer (acquiring financial institution) is also shown as part of the system 100 in FIG. 1. The acquirer computer 106 may receive a payment account system authorization request message for the transaction from the merchant device 104. The acquirer computer 106 may route the authorization request message via a card network 108 to a server computer 110 operated by the issuer of a payment account that is associated with the account number obtained by the merchant device 104 (e.g., from the customer device 102) and included in the authorization request message. The authorization response message generated by the payment issuer server computer 110 may be routed back to the merchant device 104 via the card network 108 and the acquirer computer 106.

One well known example of a card network is the network operated by Mastercard International Incorporated, which is the assignee hereof.

The payment account issuer server computer 110 may be operated by or on behalf of a financial institution (“FI”) that issues payment accounts to individual users such as the customer who presented or operated the customer device 102 referred to above. For example, the payment card issuer server computer 110 may perform such functions as (a) receiving and responding to requests for authorization of payment account transactions to be charged to payment accounts issued by the FI; and (b) tracking and storing transactions and maintaining account records.

Generally within two or three days after the authorization request and response messaging, the transaction is cleared between the issuer and the acquirer via a settlement system (not shown in FIG. 1) that is operated under the auspices of the payment card network 108.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their devices, as well as a very large number of customer devices.

The present inventors have recognized an opportunity to provide a system that offers merchants an option for more rapid payment transaction settlement (i.e., faster access to funds represented by purchase proceeds), without changing the payment system in a manner that requires additional investments by merchants in infrastructure at the point of sale.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram of a conventional payment card network arrangement.

FIG. 2 is a block diagram of a payment system provided according to aspects of the present disclosure.

FIGS. 3 and 4 are respectively block diagram illustrations of computer systems that may play a role in the payment system of FIG. 2.

FIG. 5 is a flow chart that illustrates a process that may be performed in the system of FIG. 2 in accordance with aspects of the present disclosure.

### DESCRIPTION

In general, and for the purpose of introducing concepts of embodiments of the present disclosure, merchants may be permitted to opt in to payment transaction settlement via an EFT (electronic funds transfer) system based on transactions accepted via a payment card account system protocol. At the level of the payment card network, the merchant's selection of EFT settlement is recognized, and the transaction is bridged to instruct the customer's bank (issuer bank) to initiate an EFT transaction with fast settlement. In the event of a failure of the EFT transaction, the payment card network may proceed with payment card system processing of the transaction, as a fallback function.

With this arrangement, merchants may enjoy faster access to the proceeds of sale transactions, without changing the manner in which they accept payments.

Teachings of the present disclosure may provide one or more of the following features or advantages, among others:

(A) Providing a solution for merchant and consumer needs to be able to use an account (e.g., bank account, wallet or stored value account) for retail payments (P2M) or Peer to Peer (P2P).

(B) Encouraging digital adoption for unbanked customers by leveraging stored value or wallet accounts.

(C) Facilitating receipt of funds by merchants using either ACH (automated clearinghouse) payment or a payment card account network; there is no requirement that the ACH network for merchants receive funds for transactions using account based payment methods.

(D) Providing settlement options for (i) either gross or net for both cross border and domestic transactions; (ii) choice of settlement currencies by which acquirers can settle; (iii) instant or batch settlement options; (iv) funds availability/settlement to acquirer, merchants or merchant aggregator.

(E) Providing in the payment network business logic for determining the settlement model.

(F) Supporting liquidity management in the event that there is an extended holiday determined by the payment account network.

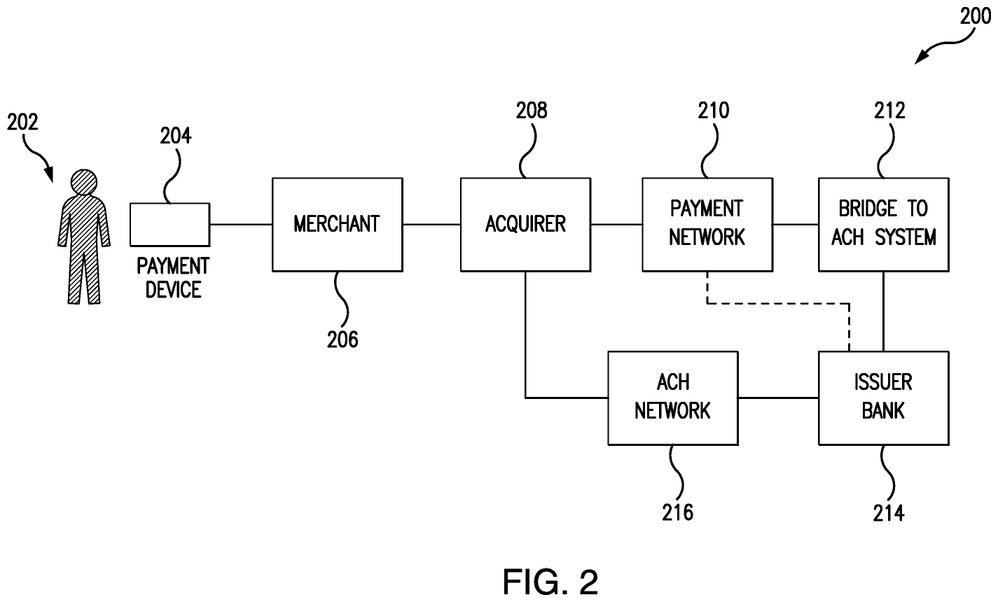

FIG. 2 is a block diagram of a payment system 200 according to some embodiments. FIG. 2 illustrates entities/devices involved in a typical transaction performed according to aspects of the present disclosure.

A customer/user of the payment system 200 is shown at 202, presenting a payment device 204 (IC payment card, magnetic stripe payment card, payment-enabled mobile device, for example) to a merchant 206. The merchant 206 is in communication with the merchant's acquirer FI 208. The acquirer 208 routes the transaction to the payment network 210. A bridging network 212 is in cooperative communication with the payment network 210. For some transactions, the bridging network routes the transaction in question to the user's issuer FI 214, for execution and settlement of the transaction between the issuer 214 and the acquirer 208 via an ACH network 216, for the benefit of the merchant 206.

While an ACH network is shown in the example embodiment illustrated in FIG. 2 as a type of EFT system usable in accordance with principles of the present disclosure, in other embodiments other varieties of EFT system may be employed.

The acceptance of the payment transaction by the merchant 206 and the routing of the transaction to the payment network 210 by the acquirer 208 may proceed in accordance with conventional practices for handling payment card account system transactions.

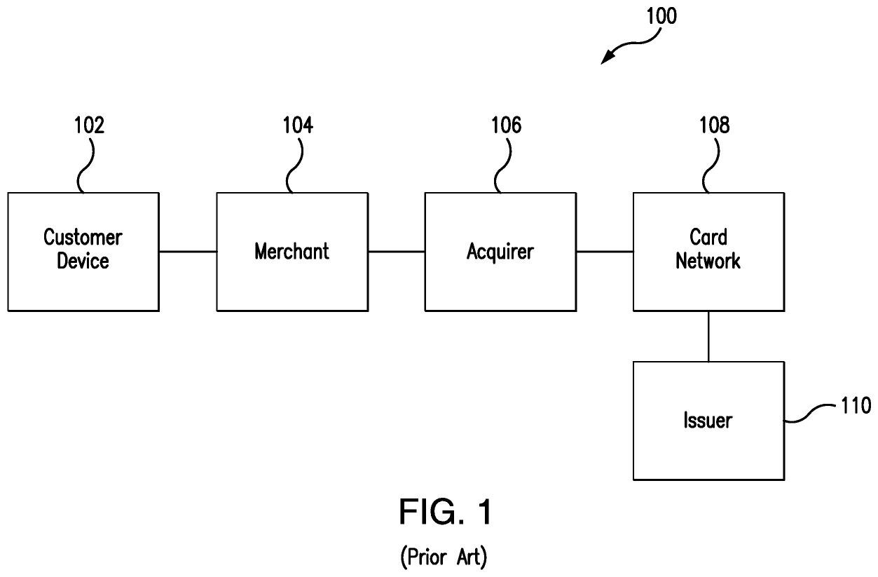

The payment network 210 may have all of the functionality of the conventional payment network 108 shown in FIG. 1, and may have additional capabilities in accordance with aspects of the present disclosure as described herein. The additional capabilities may include determining that the merchant has selected ACH settlement for the current payment transaction, and processing and dispatching the transaction accordingly, in cooperation with the bridging network 212. In some embodiments, the payment network 210 and the bridging network 212 may both be operated by the same organization, and may be closely interlinked with each other. Further details of the payment network 210 and the bridging network 212 will be discussed below.

For purposes of the current example, it is assumed that the issuer 214 and the acquirer 208 are participants in the ACH network 216, as well as being members of the payment card account system centered around the payment network 210.

Each block in FIG. 2 that represents an entity should also be understood to represent one or more computers operated by or on behalf of that entity.

The payment system 200 is illustrated in FIG. 2 in the context of a single transaction. However, in a practical embodiment of the payment system 200, it may handle numerous transactions, including numerous simultaneous transactions. The system 200 may include many other issuers and acquirers besides those shown in FIG. 2. Many merchants may participate in the payment system 200, as may numerous holders of payment card system accounts and/or bank deposit accounts.

In the example transaction of FIG. 2, it is assumed that the acceptance of the payment transaction occurs at the point of sale in a retail store. Alternatively, however, the transaction may arise from an online purchase, implemented through an e-commerce website operated by the merchant 206.

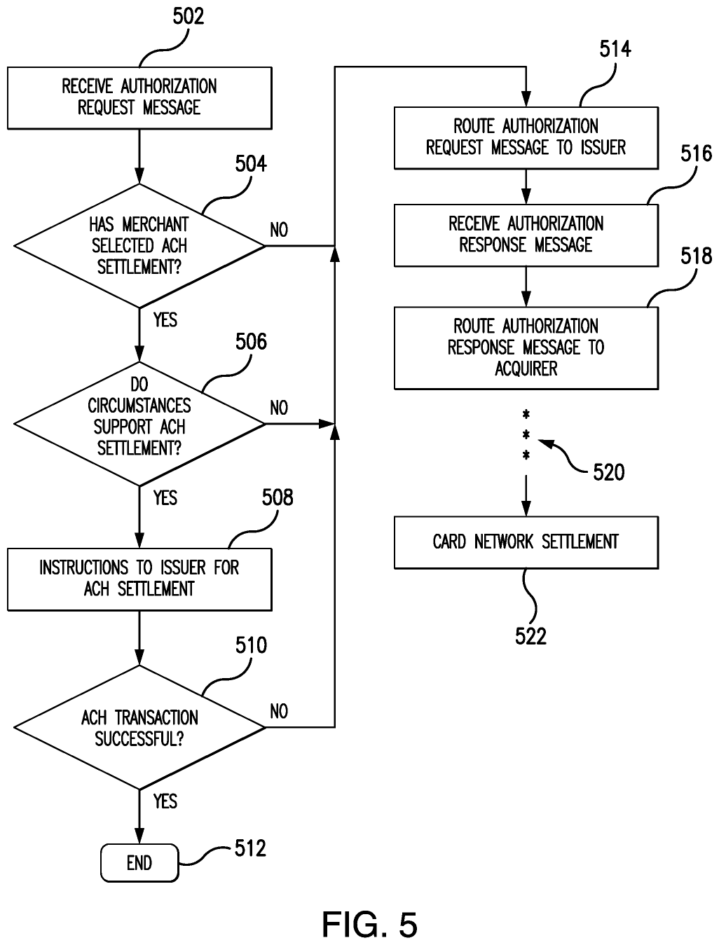

An example of operation of the payment system 200 will be described below, particularly with reference to FIG. 5. First, though, there will be a further description of some components of the payment system 200.

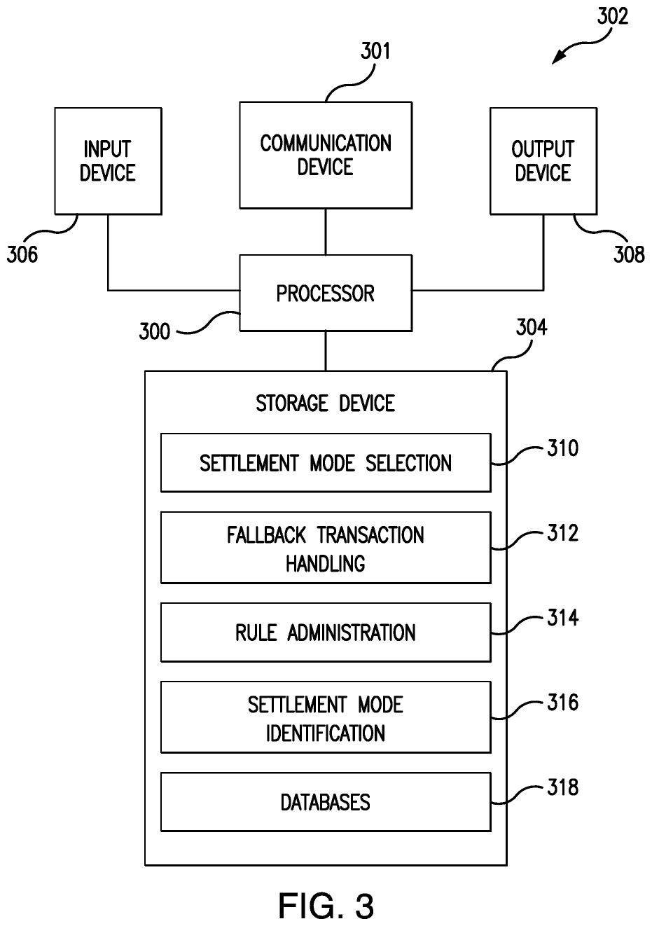

FIG. 3 is a block diagram that illustrates an example embodiment of a computer system 302 that may implement at least some functions of the bridging network 212 shown in FIG. 2. The computer 302 will therefore be referred to as the “bridging network computer.” The bridging network computer 302 may, in its hardware aspects, resemble a typical mainframe or server computer, but may be controlled by software to cause it to function as described herein.

Referring to FIG. 3, the bridging network computer 302 may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more processors. Processor 300 operates to execute processor-executable steps, contained in program instructions described below, so as to control the bridging network computer 302 to provide desired functionality.

Communication device 301 may be used to facilitate communication with, for example, other devices such as computers operated by or on behalf of acquirers and issuers and/or with one or more computers that implement the payment network 210. Communication device 301 may comprise numerous communication ports (not separately shown), to allow the bridging network computer 302 to communicate simultaneously with a considerable number of other computers, and/or to simultaneously handle numerous transactions.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the bridging network computer 302, executed by the processor 300 to cause the bridging network computer 302 to function as described herein.

The programs may include one or more conventional operating systems (not shown) that control the processor 300 so as to manage and coordinate activities and sharing of resources in the bridging network computer 302, and to serve as a host for application programs (described below) that run on the bridging network computer 302.

The storage device 304 may also store a settlement mode selection application program 310. The settlement mode selection application program 310 may control the bridging network computer 302 to select a settlement mode for a given transaction, based on merchant/acquirer preferences and/or other factors. In doing so, the settlement mode selection application program 310 may select between ACH settlement and payment card account system settlement for the transaction.

The storage device 304 may in addition store a fallback transaction handling application program 312. The fallback transaction handling application program 312 may operate such that, if an ACH transaction for settlement fails, the transaction goes on to be handled as a payment card account system transaction, with settlement via the payment card account settlement system. With the fallback transaction handling application program 312, the bridging network computer 302 may support a seamless and consistent set of rules across both settlement modes.

The programs stored in the storage device 304 may also include a rule administration application program 314. The rule administration application program 314 controls the processor 300 such that bridging network computer 302 implements a set of overarching rules that govern all transactions across both settlement modes.

Still further, the storage device 304 may store a settlement mode indication application program 316. The settlement mode indication application program 316 may provide indicators in transaction messaging to identify which of the two settlement modes is to be applied in the payment system for a given transaction.

Continuing to refer to FIG. 3, the storage device 304 may also store, and bridging network computer 302 may also execute, other programs, which are not shown. For example, such programs may include communications software and a reporting application. The latter program may respond to requests from system administrators for reports on the activities performed by the bridging network computer 302. The other programs may also include, e.g., device drivers, database management software, etc.

Moreover, the storage device 304 may also store one or more databases 318 needed for operation of the bridging network computer 302.

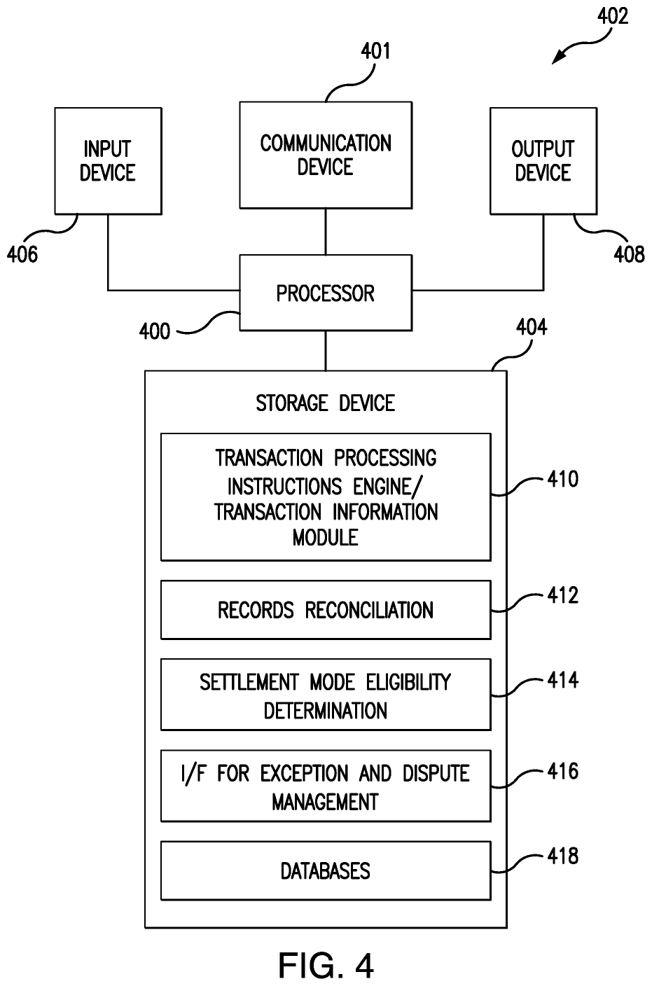

FIG. 4 is a block diagram that illustrates an example embodiment of a computer system 402 operated by or for the payment network 210 shown in FIG. 2. The computer system 402 will hereinafter be referred to as the “payment network computer.” The payment network computer 402 may have the same type of architecture and may feature the same types of components as discussed above in connection with FIG. 3. Referring to FIG. 4, the payment network computer 402 may include a computer processor 400 operatively coupled to a communication device 401, a storage device 404, an input device 406 and an output device 408. The communications device 401, the storage device 404, the input device 406 and the output device 408 may all be in communication with the processor 400.

Storage device 404 stores one or more programs for controlling processor 400. The programs comprise program instructions (which may be referred to as computer readable program code means) that contain processor-executable process steps of the payment network computer 402 executed by the processor 400 to cause the payment network computer 402 to function as described herein.

The programs may include one or more conventional operating systems (not shown) that control the processor 400 so as to manage and coordinate activities and sharing of resources in the payment network computer 402, and to serve as a host for application programs (described below) that run on the payment network computer 402.

The storage device 404 may also store a transaction processing instructions engine and related transaction information module (both represented at block 410 in FIG. 4). The instructions engine/information module 410 may control the processor 400 such that the payment network computer 402 provides corresponding instructions to the relevant financial institution(s) as to whether the transaction should be processed as a payment card account system settlement or an ACH settlement. In addition, the instructions engine/information module 410 may—in the case of an ACH settlement—provide sufficient information to the issuer to debit an account “on-us” and to credit the receiving account through the ACH network. Furthermore, in the case of payment card account system settlement, the instructions engine/information module 410 may provide sufficient information to the issuer to debit an account “on-us” and to credit an “on-us” temporary account for payment card account system settlement.

The programs stored in the storage device 404 may also include, for example, a records reconciliation application program 412. The records reconciliation application program 412 controls the processor 400 such that the payment network computer 402 may manage all the reconciliation records between the various types of settlement transactions processed.

Still further, the storage device 404 may store a settlement mode eligibility determination application program 414. The settlement mode eligibility determination application program 414 controls the processor 400 such that the payment network computer 402 determines for a given transaction, whether it is eligible for a settlement mode proposed for the transaction.

In addition, the storage device 404 may store a software interface for exception and dispute management 416. This may allow the payment network computer 402 to provide a common interface for system participants for exceptions and disputes.

The storage device 404 may also store, and the payment network computer 402 may also execute, other programs, which are not shown. For example, such programs may include communications software, and a reporting application. The latter program may respond to requests from system administrators for reports on the activities performed by the payment network computer 402. The other programs may also include, e.g., device drivers, database management software, etc.

Moreover, the storage device 404 may store one or more databases 418 needed for operation of the payment network computer 402.

Other computer components of the payment system 200 of FIG. 2 may have a similar architecture and/or similar components as were described in connection with FIG. 3.

FIG. 5 is a flow chart that illustrates an example of a process that may be performed in the payment system 200 of FIG. 2, according to aspects of the present disclosure.

The ensuing discussion of FIG. 5 assumes that merchants and/or acquirers have been previously provided, by the payment system 200, opportunities to opt in for/select ACH settlement for at least some transactions accepted/processed by those parties. The ensuing discussion further assumes that at least some of the merchants/acquirers have in fact selected ACH settlement for at least some of their transactions, and that an indication of such selection has been stored in the payment network computer 402 and/or the bridging network computer 302. The process of FIG. 5 is presented from the viewpoint of the payment network computer 402 and the bridging network computer 302, working cooperatively together and in communication with each other. Each process step illustrated in FIG. 5 is performed by the payment network computer 402 and/or the bridging network computer 302.

At block 502 in FIG. 5, a payment card account system transaction authorization request message is received from the acquirer 208 (FIG. 2). It will be appreciated that the payment card account system transaction authorization request message represents a payment transaction that was accepted by the merchant 206 and initiated by the user 202 via his/her payment device 204. The payment card account system transaction authorization request message may include data elements usually included in such messages, such as merchant identifier, transaction amount and an EMV cryptogram (i.e., a cryptogram generated at the point of sale in accordance with a standard issued by EMVCo).

Continuing to refer to FIG. 5, a decision block 504 may follow block 502. At decision block 504, it is determined whether the merchant (or alternatively, the acquirer) has selected ACH settlement for the payment transaction in question. If so, then decision block 506 may follow decision block 504. At decision block 506, it is determined whether circumstances are such that the selection of ACH settlement can be implemented. For example, at decision block 506, it may be determined whether the payment transaction in question is eligible for ACH settlement.

If a positive determination is made at decision block 506 (i.e., if it is determined that the selected ACH settlement can be implemented), then block 508 may follow decision block 506. At block 508 instructions are transmitted to the issuer 214 (FIG. 2) to cause the issuer 214 to execute an ACH transaction in the transaction amount to transfer funds from the purchaser's account at the issuer 214 to the acquirer 208—via the ACH network 216 (FIG. 2)—for the benefit of the merchant 206.

Continuing to refer to FIG. 5, a decision block 510 may follow block 508. At decision block 510, it is determined whether a confirmation is received that the ACH transaction was successfully performed. If so, it may be assumed that the acquirer 208 provided confirmation of payment to the merchant 206, and that the purchase transaction between the merchant 206 and the customer/user 202 has been consummated. Consequently, as indicated at 512, the processing of the transaction by the payment network computer 402 and the bridging network computer 302 has been completed.

Considering again decision block 504, if a negative determination is made at that decision block (i.e., if ACH settlement was not selected for the transaction), then block 514 may follow decision block 504. At block 514, the payment account system transaction authorization request message received at 502 is routed to the issuer 214 (FIG. 2). Block 516 may follow block 514. At block 516, a payment account system transaction authorization response message is received from the issuer 214. Block 518 may follow block 516. At block 518, the payment account system transaction authorization response message received at 516 may be routed to the acquirer 208.

It may be assumed that the response from the issuer was favorable, and that the acquirer 208 so informs (by suitable message) the merchant 206, such that the purchase transaction between the merchant 206 and the customer/user 202 is consummated.

After passage of a period of time, as represented by ellipsis 520, block 522 may follow. At block 522, the payment transaction that was the subject of the messaging at blocks 502, 514, 516 and 518 may be settled via the payment transaction settlement system operated under the auspices of the operator of the payment network 210. In a typical case, the settlement may occur two or three days after the authorization request and response messaging.

When it is the case that the process flow branches to blocks 514, etc., the handling of the payment transaction (apart from the decisioning at decision block 504) may be essentially the same as handling of a typical transaction in the conventional payment card account system discussed in connection with FIG. 1.

Considering again decision block 506, if a negative determination is made at that decision block (i.e., if implementation of ACH settlement is not determined to be supported for the current transaction), then the process may branch from decision block 506 to blocks 514, etc., as described above.

Considering again decision block 510, if a negative determination is made at that decision block (i.e., if an indication is received that the ACH transaction (block 508) has failed), then the process may branch, as a fallback to the ACH settlement, to handling and settlement as a payment card account system transaction, via blocks 514, etc. as discussed above.

With a payment system as described above in connection with FIGS. 2-5, a merchant may have a choice as to how settlement is performed with respect to a payment transaction accepted by the merchant in accordance with payment card account system transaction acceptance practices. The merchant may be allowed to opt for ACH settlement of such transactions, thereby obtaining for the merchant virtually real-time access (or very prompt access) to the proceeds of a sales transaction, in contrast to the later availability of funds in connection with payment card account system settlement practices. Moreover, with the system of FIG. 2, there is a fallback procedure available in the event that a requested ACH transaction fails—i.e., the payment card account system transaction handling capabilities may serve as a fallback for failed ACH transactions.

Furthermore, the payment system of FIG. 2 may provide a consistent set of rules and exception processing to be applied for both ACH-settled and payment-account-system-settled transactions.

According to other aspects of this disclosure, benefits of rapid (e.g., real-time) settlement may be provided within the framework of the payment network itself, and its associated settlement facilities, without including ACH settlement. The system may resemble that illustrated in FIG. 1, but with enhanced settlement capabilities.

According to these aspects of this disclosure, acquirer and issuer banks are provided with options, by the payment card system, to engage in real-time settlement. If, for a given transaction, real-time settlement proves not to be available, the standard payment card system settlement processes (as referred to above in connection with FIG. 1) may serve as a fallback option. Transaction messaging may include an indication that real-time settlement is to be implemented for the current transaction.

The following functionality may be incorporated in the payment network to implement network-based real-time settlement. For a given transaction, the network may determine whether the transaction is eligible for real-time settlement. (For example, a “hold” transaction, as at a gas pump or at hotel check-in, may not be eligible for real-time settlement.) For the current transaction, the network may also determine that both the acquirer and the issuer are participants in the real-time settlement arrangement, and that the issuer is in good standing. If all of these checks result in a satisfactory outcome, the network may provide instructions to the issuer to debit the user/customer's account and put the funds in a holding account. For this transaction, the acquirer is to make funds available to the merchant in real-time. The network may also provide a summary of activities and reconciliation to the acquirer for the real-time settlement. The network may ensure that the acquirer settles at the defined timeframe based on the central bank settlement window in the market in which the acquirer and issuer operate. The payment network transactions may all be governed by the same payment scheme rules, regardless of the timing at which settlement occurs. Settlement timing and windows may have no impact on protections for and liability of users/account holders.

With an approach as provided according to this aspect of the disclosure, merchants may enjoy improved working capital management because of real-time funds availability for payment card network transactions. This may especially benefit smaller merchants who traditionally deploy working capital to buy goods against upfront payments. Moreover, with this real-time settlement arrangement within the payment network environment, acquirers and issuers can use their existing connectivity and service with the payment network for transaction reconciliation and settlement.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omission of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” or “payment account system” or “payment card account system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific example embodiments, it should be understood that various changes, substitutions, and alterations apparent to those skilled in the art can be made to the disclosed embodiments without departing from the spirit and scope of the appended claims.

What is claimed is:

1. A method comprising:
receiving a payment card account system transaction request initiated by acceptance of a payment card account transaction by a merchant, said transaction request including a transaction amount;
determining whether the merchant has selected EFT (electronic funds transfer) settlement for the accepted payment card account transaction; and
responding to said receiving step and a result of said determining step by routing an EFT transaction request for said transaction amount to an EFT system to benefit the merchant.

2. The method of claim 1, wherein the EFT system is an ACH (automated clearinghouse) system.

3. The method of claim 1, wherein said routing includes routing the EFT transaction request to an issuer financial institution that maintains an account for a user who initiated said payment card account transaction.

4. The method of claim 1, further comprising:
receiving a message that indicates failure of an EFT transaction requested by said EFT transaction request; and
in response to receiving said message, routing a payment card account system transaction authorization request message to an issuer financial institution that maintains an account for a user who initiated said payment card account transaction.

5. The method of claim 4, further comprising:
receiving a payment card account system transaction authorization response message from the issuer financial institution.

6. The method of claim 5, further comprising:
settling said payment card account transaction in a payment card account transaction settlement system.

7. The method of claim 1, wherein said payment card account system transaction request includes an EMV cryptogram generated during said accepted payment card account transaction.

8. An apparatus comprising:
a processor; and
a memory in communication with the processor, the memory storing program instructions, the processor operative with the program instructions to perform functions as follows:
receiving a payment card account system transaction request initiated by acceptance of a payment card account transaction by a merchant, said transaction request including a transaction amount;
determining whether the merchant has selected EFT (electronic funds transfer) settlement for the accepted payment card account transaction; and
responding to said receiving step and a result of said determining step by routing an EFT transaction request for said transaction amount to an EFT system to benefit the merchant.

9. The apparatus of claim 8, wherein the EFT system is an ACH (automated clearinghouse) system.

10. The apparatus of claim 8, wherein said routing includes routing the EFT transaction request to an issuer financial institution that maintains an account for a user who initiated said payment card account transaction.

11. The apparatus of claim 8, wherein the processor is further operative with the program instructions to:
receive a message that indicates failure of an EFT transaction requested by said EFT transaction request; and
in response to receiving said message, route a payment card account system transaction authorization request message to an issuer financial institution that maintains an account for a user who initiated said payment card account transaction.

12. The apparatus of claim 11, wherein the processor is further operative with the program instructions to receive a payment card account system transaction authorization response message from the issuer financial institution.

13. The apparatus of claim 12, wherein the processor is further operative with the program instructions to settle said payment card account transaction in a payment card account transaction settlement system.

14. The apparatus of claim 8, wherein said payment card account system transaction request includes an EMV cryptogram generated during said accepted payment card account transaction.

15. A method comprising:
receiving a payment card account system transaction request initiated by acceptance of a payment card account transaction by a merchant, said transaction request including a transaction amount;
determining whether an acquirer bank has selected EFT (electronic funds transfer) settlement for the accepted payment card account transaction, said acquirer bank engaged to perform services for the merchant; and
responding to said receiving step and a result of said determining step by routing an EFT transaction request for said transaction amount to an EFT system to benefit the merchant.

16. The method of claim 15, wherein the EFT system is an ACH (automated clearinghouse) system.

17. The method of claim 15, wherein said routing includes routing the EFT transaction request to an issuer financial institution that maintains an account for a user who initiated said payment card account transaction.

18. The method of claim 15, further comprising:
receiving a message that indicates failure of an EFT transaction requested by said EFT transaction request; and
in response to receiving said message, routing a payment card account system transaction authorization request message to an issuer financial institution that maintains an account for a user who initiated said payment card account transaction.

19. The method of claim 18, further comprising:
receiving a payment card account system transaction authorization response message from the issuer financial institution.

20. The method of claim 19, further comprising:
settling said payment card account transaction in a payment card account transaction settlement system.
